(19) United States
(12) Patent Application Publication
(10) Pub. No.: US 2023/0393553 A1
(43) Pub. Date: Dec. 7, 2023

(54) AUTONOMOUS VEHICLES WITH THREE-DIMENSIONAL PRINTERS

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/829,570

(22) Filed: Jun. 1, 2022

(51) Int. Cl. G05B 19/4099; B29C 64/386; B33Y 50/00; B33Y 99/00; B60W 60/00; B60W 40/10

(52) U.S. Cl. CPC G05B 19/4099; B29C 64/386; B33Y 50/00; B33Y 99/00; B60W 60/001; B60W 40/10; G05B 2219/49023

(57) ABSTRACT

An AV includes a 3D printer. The AV obtains a request to 3D print an object, e.g., based on identification of a feature associated with the AV or a user input. The AV can control the 3D printing process based on a motion of the AV that occurs during the 3D printing process. The AV may determine an influence of the motion on the 3D printing process and adjust the 3D printing process to compensate for the influence. Also, the AV may determine a motion during the 3D printing process to facilitate the 3D printing process, e.g., facilitate a movement of an item associated with the 3D printing process. The item may be at least a part of the 3D printer, a material from which the object is printed, or a portion of the object. A fleet management system can manage 3D printing services provided by a fleet of AVs.

### TECHNICAL FIELD OF THE DISCLOSURE

The present disclosure relates generally to autonomous vehicles (AVs) and, more specifically, to AVs with three-dimensional (3D) printers.

### BACKGROUND

An AV is a vehicle that is capable of sensing and navigating its environment with little or no user input. An autonomous vehicle may sense its environment using sensing devices such as Radio Detection and Ranging (RADAR), Light Detection and Ranging (LIDAR), image sensors, cameras, and the like. An autonomous vehicle system may also use information from a global positioning system (GPS), navigation systems, vehicle-to-vehicle communication, vehicle-to-infrastructure technology, and/or drive-by-wire systems to navigate the vehicle. As used herein, the phrase “autonomous vehicle” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a system including a fleet of AVs that can provide 3D printing services, according to some embodiments of the present disclosure;

FIG. 2 is a block diagram showing a sensor suite, according to some embodiments of the present disclosure;

FIG. 3 is a block diagram showing an onboard computer, according to some embodiments of the present disclosure;

FIG. 4 is a block diagram showing a fleet management system, according to some embodiments of the present disclosure;

FIG. 5 illustrates an example 3D printer in an AV, according to some embodiments of the present disclosure;

FIG. 6 is a flowchart showing a method of controlling operation of a 3D printer in a vehicle based on a motion of the vehicle, according to some embodiments of the present disclosure;

FIG. 7 is a flowchart showing a method of controlling a motion of a vehicle to facilitate operation of a 3D printer in the vehicle, according to some embodiments of the present disclosure; and

FIG. 8 is a flowchart showing a method of providing 3D printing service by using an AV, according to some embodiments of the present disclosure.

### DESCRIPTION OF EXAMPLE EMBODIMENTS OF THE DISCLOSURE

Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

As described herein, 3D printers can be arranged in AVs and print 3D objects that can be used to facilitate operations of the AVs or services provided by the AVs. A 3D printing process may be automatically initiated by an AV. The AV's sensor suite may detect a feature that indicates a need of printing a 3D object. In an example, the AV detects one or more features in an environment around the AV that indicates an adverse weather condition, road condition, or other conditions that can be dealt with by using a 3D printed object. In another example, the AV detects malfunctioning of a feature, which can be replaced with a 3D printed object. The feature may be a part of the AV, a device for facilitating the AV's operation, a device for facilitating a service that the AV can provide, or other types of features associated with the AV. The AV may instruct the 3D printer to print the object, and the 3D printer may operate during motions of the AV, e.g., during a navigation of the AV from one location to another.

The AV may control the operation of the 3D printer based on its motion(s). The AV may determine a motion that it will make during the operation of the 3D printer. The AV may determine the motion based on environmental conditions, e.g., weather conditions, road conditions, etc. The AV generates a printing instruction for the 3D printer based on the motion provides the printing instruction to the 3D printer and the 3D printer will operate in accordance with the printing instruction. In an example, the AV determines an influence of the motion on a condition of an item associated with the 3D printing process. The item may be at least part of the 3D printer, a material used by the 3D printer to print the object, a portion of the object, etc. The influence may be a movement of the item caused by the motion or a change to the operation of the item during the motion. The AV can adjust the condition of the item to compensate for the influence so that the 3D printer can operate properly during the motion of the AV.

The AV may control its motions to facilitate 3D printing. In some embodiments, the AV may modify its motion to facilitate a 3D printing process by the 3D printer in the AV. For instance, the AV may change its driving speed (e.g., come to a stop, drive more slowly, drive faster, etc.), its driving route (e.g., avoid upward or downward slopes, take more upward or downward slopes, avoid speed bumps, take more speed bumps, avoid turns, make more turns, etc.), or modify its motions in other ways. The AV may analyze the 3D printing process and determine one or more printing parameters. A printing parameter may indicate a condition of an item associated with the 3D printing process during the 3D printing process. The AV further determines a motion based on the one or more printing parameters. In an example, a printing parameter indicates a movement of an item during the 3D printing process, and the AV determines a motion that can cause or promote the movement of the item. In another example, a printing parameter indicates an operation limit of an item, and the AV determines a motion during which the item can operate within the operation limit.

Users can request AVs to provide 3D printed objects. A fleet management system may manage a fleet of AVs that can provide 3D printing services. The fleet management system may receive 3D printing requests from user devices and selects an AV from the fleet based on the 3D printing request. The fleet management system may select an AV that is available and capable for serving the 3D printing request. For instance, the AV does not perform any other tasks to perform during the time to service the 3D printing request and the AV has a 3D printer that can form the requested object. The fleet management system may also consider other factors, e.g., physical proximity, convenience, efficiency, etc. After selecting an AV, the fleet management system dispatches the AV to perform the 3D printing task. The fleet management system may provide navigation instruction to the AV and the AV may navigate to a location (e.g., a location indicated in the 3D printing request) based on the navigation instruction. The 3D printer in the AV may perform at least part of the 3D printing process during the navigation of the AV. The fleet management system may further provide instructions to control the AV's motion during the 3D printing process or to control the operation of the 3D printer.

As will be appreciated by one skilled in the art, aspects of the present disclosure, in particular aspects of AV sensor calibration, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

Example AV Environment

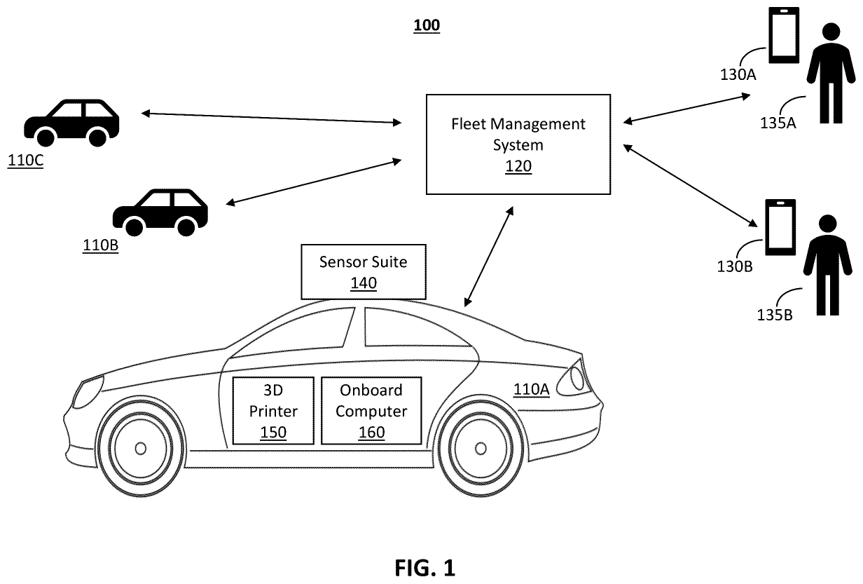

FIG. 1 illustrates a system 100 including a fleet of AVs that can provide 3D printing services, according to some embodiments of the present disclosure. The system 100 includes a fleet of AVs 110A-C (collectively referred to as “AV 110” or “AVs 110”), a fleet management system 120, and user devices 130A and 130B (collectively referred to as “user device 130” or “user devices 130”). For purpose of simplicity and illustration, in FIG. 1, the AV 110A includes a sensor suite 140 and an onboard computer 160. The AV 110B or 110C may also include a sensor suite 140 and an onboard computer 160. In other embodiments, the system 100 may include fewer, more, or different components. For instance, the system 100 may include a different number of AVs 110, a different number of user devices 130, etc.

The fleet management system 120 receives service requests for the AVs 110 from the user devices 130. As shown in FIG. 1, the user devices 130A and 130B are associated with users 135A and 135B, respectively. The users 135A and 135B are collectively referred to as “user 135” or “users 135.” In other embodiments, a single user device 130 may be associated with multiple users 135. Also, a single user 135 may be associated with multiple user devices 130. A user device 130 may be one or more computing devices capable of receiving user input as well as transmitting and/or receiving data via one or more networks, e.g., a network through which the user device 130 can communicate with the fleet management system 120. In one embodiment, a user device 130 is a conventional computer system, such as a desktop or a laptop computer. Alternatively, a user device 130 may be a device having computer functionality, such as a personal digital assistant (PDA), a mobile telephone, a smartphone, or another suitable device.

In some embodiments, a user device 130 executes an application allowing a user 135 of the user device 130 to interact with the fleet management system 120. For example, a user device 130 executes a browser application to enable interaction between the user device 130 and the fleet management system 120 via a network. In another embodiment, a user device 130 interacts with the fleet management system 120 through an application programming interface (API) running on a native operating system of the user device 130, such as IOS® or ANDROID™. The application may be provided and maintained by the fleet management system 120. The fleet management system 120 may also update the application and provide the update to the user device 130.

In some embodiments, a user 135 may make various service requests to the fleet management system 120 through a user device 130. A user device 130 may provide its user 135 a user interface (UI), through which the user 135 can make service requests. An example service request is a 3D printing request, e.g., a request to use a 3D printer in an AV 110 to form an object. In addition to 3D printing request, a user 135 may make other service requests, such as ride requests (e.g., a request to pick up a person from a pickup location and drop off the person at a destination location), delivery requests (e.g., a request to delivery one or more items from a location to another location), and so on. In some embodiments, a user 135 may make a service request that includes multiple services. For example, a user 135 may request an AV 110 to 3D print an object and to deliver the object (or use the object to deliver another object) to a location. Such a request combines a 3D printing request and a delivery request. As another example, a user 135 may request an AV to provide a ride and to 3D print an object during the ride. Such a request combines a 3D printing request and a ride request. The UI may allow users 135 to provide locations (e.g., pickup location, destination location, etc.) or other information that would be needed by AVs 110 to provide services requested by the users 135.

The AV 110 may be a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. In some embodiments, some or all of the vehicle fleet managed by the fleet management system 120 are non-autonomous vehicles dispatched by the fleet management system 120, and the vehicles are driven by human drivers according to instructions provided by the fleet management system 120.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc.

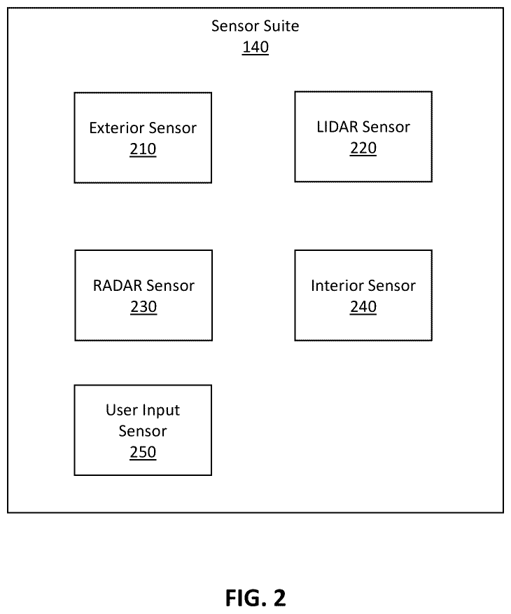

As shown in FIG. 1, the AV 110 includes a sensor suite 140, a 3D printer 150, and an onboard computer 160. The sensor suite 140 includes one or more sensors that can detect one or more features associated with the AV 110. Example features include features in an environment around the AV 110, features on the exterior of the AV 110, features inside the AV 110, and so on. The sensor suite 140 may include a computer vision (“CV”) system, localization sensors, and driving sensors. For example, the sensor suite 140 may include interior and exterior cameras, RADAR sensors, sonar sensors, LIDAR sensors, thermal sensors, wheel speed sensors, inertial measurement units (IMUS), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Certain aspects of the sensor suite 140 are described below in conjunction with FIG. 2.

The 3D printer 150 can print 3D objects from materials, such as polymers, metals, and so on. In some embodiments the 3D printer 150 receives description of an object and can print the object based on the description. The description may include a virtual representation of the object, such as a 3D model. The 3D printer 150 may receive the description of the object from one or more sources, such as the sensor suite 140 (e.g., one or more sensors in the sensor suite 140 can scan the object and generate the description), the onboard computer 160 (e.g., the onboard computer 160 can receive the description of the user or generate the description based on sensor data from the sensor suite 140), database of objects, the fleet management system 120, other sources, or some combination thereof.

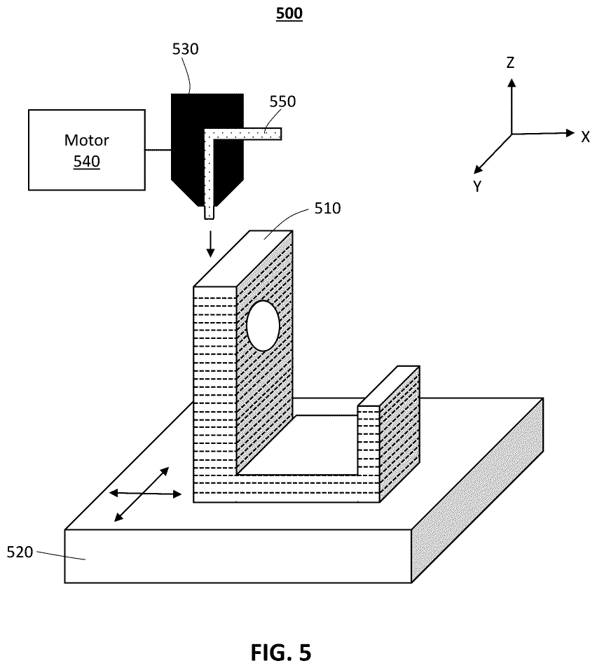

The 3D printer 150 (or a component thereof) may be fixed in the AV 110. The 3D printer 150 may operate during navigation of the AV 110. For instance, the 3D printer 150 can be activated as the AV 110 drives to print an object. In some embodiments, the 3D printer 150 operates under instructions provided by the onboard computer 160. Even though FIG. 1 shows a single 3D printer 150, the AV 110 may include multiple 3D printers, which may have different configurations. Certain aspects of the 3D printer 150 are described below in conjunction with FIG. 5.

The onboard computer 160 is connected to the sensor suite 140 and functions to control the AV 110 and to process sensed data from the sensor suite 140 and/or other sensors in order to determine the state of the AV 110. Based upon the vehicle state and programmed instructions, the onboard computer 160 modifies or controls behavior of the AV 110. The onboard computer 160 is preferably a general-purpose computer adapted for I/O communication with vehicle control systems and sensor suite 140, but may additionally or alternatively be any suitable computing device. The onboard computer 160 is preferably connected to the Internet via a wireless connection (e.g., via a cellular data connection). Additionally or alternatively, the onboard computer 160 may be coupled to any number of wireless or wired communication systems.

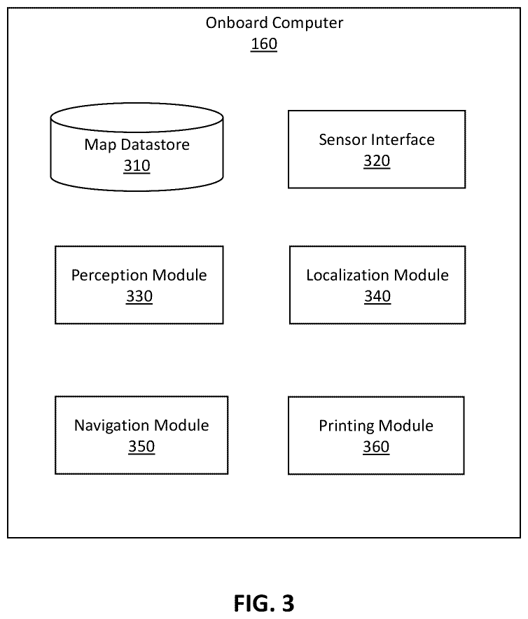

The onboard computer 160 facilitates 3D printing services provided by the AV 110. The onboard computer 160 is connected to the 3D printer 150 and controls operation of the 3D printer 150. For instance, the onboard computer 160 may control operation of the 3D printer 150 based on the motions of the AV 110. Additionally or alternatively, the onboard computer 160 may control (e.g., modify) motions of the AV 110 to facilitate the operation of the 3D printer 150. Example motions of an AV 110 may be acceleration, deacceleration, turning, vibration, ascending, descending, other types of movements, or some combination thereof. Certain aspects regarding the onboard computer 160 are described below in conjunction with FIG. 3.

The fleet management system 120 manages the fleet of AVs 110. The fleet management system 120 may manage one or more services that provides or uses the AVs, e.g., 3D printing service, ride service, delivery service, and so on. The fleet management system 120 selects one or more AVs (e.g., AV 110A) from a fleet of AVs 110 to perform a particular service or other task, and instructs the selected AV to provide the service. The fleet management system 120 may also send the selected AV information that the selected AV may use to complete the service. The fleet management system 120 also manages fleet maintenance tasks, such as fueling, inspecting, calibrating, and servicing of the AVs. As shown in FIG. 1, the AVs 110 communicate with the fleet management system 120. The AVs 110 and fleet management system 120 may connect over a public network, such as the Internet. More information regarding onboard computer is provided below in conjunction with FIG. 2.

Example Sensor Suite

FIG. 2 is a block diagram showing the sensor suite 140, according to some embodiments of the present disclosure. The sensor suite 140 includes an exterior sensor 210, a LIDAR sensor 220, a RADAR sensor 230, an interior sensor 240, and a user input sensor 250. The sensor suite 140 may include any number of the types of sensors shown in FIG. 2, e.g., one or more exterior sensor 210, one or more LIDAR sensors 220, etc. The sensor suite 140 may have more types of sensors than those shown in FIG. 2, such as the sensors described with respect to FIG. 1. In other embodiments, the sensor suite 140 may not include one or more of the sensors shown in FIG. 2.

The exterior sensor 210 detects environmental features around the AV 110. An environment feature is a feature in the environment around the AV 110. Example environmental features include weather features (e.g., rain, snow, hail, haze, wind, etc.), road features (e.g., speed bump, construction cone, curve, ice patch, tree, building, other vehicles, pedestrian, etc.), or other types of features in the environment around the AV 110. In some embodiments, the exterior sensor 210 also detects exterior features of the AV 110. An exterior feature may be a feature that is arranged at the exterior of the AV 110. An exterior feature may be a part of the AV 110 (e.g., handle, light fixture, mirror fixture, etc.), an accessory (e.g., rack, holder, carrier, hitch, ball mount, etc.), a component of an accessory, and so on. The exterior sensor 210 may transmit sensor data to a perception module (such as the perception module 330 described below in conjunction with FIG. 3), which can use the sensor data to classify a feature and/or to determine a status of a feature.

In some embodiments, the exterior sensor 210 includes exterior cameras having different views, e.g., a front-facing camera, a back-facing camera, and side-facing cameras. One or more exterior sensor 210 may be implemented using a high-resolution imager with a fixed mounting and field of view. One or more exterior sensors 210 may have adjustable field of views and/or adjustable zooms. In some embodiments, the exterior sensor 210 may operate continually during operation of the AV 110.

The LIDAR sensor 220 measures distances to objects in the vicinity of the AV 110 using reflected laser light. The LIDAR sensor 220 may be a scanning LIDAR that provides a point cloud of the region scanned. The LIDAR sensor 220 may have a fixed field of view or a dynamically configurable field of view. The LIDAR sensor 220 may produce a point cloud that describes, among other things, distances to various objects in the environment of the AV 110.

The RADAR sensor 230 can measure ranges and speeds of objects in the vicinity of the AV 110 using reflected radio waves. The RADAR sensor 230 may be implemented using a scanning RADAR with a fixed field of view or a dynamically configurable field of view. The RADAR sensor 230 may include one or more articulating RADAR sensors, long-range RADAR sensors, short-range RADAR sensors, or some combination thereof.

The interior sensor 240 detects interior features of the AV 110. An interior feature is a feature inside the AV 110. Examples of an interior feature include a component of the AV 110, an item delivered by the AV 110 (such as grocery item, package, etc.), a device facilitating a service that the AV 110 can provide (such as handles, hooks, containers, etc.), a device facilitating operation of the AV 110 (such as a tool for handling adverse weather conditions (e.g., shovels, scratchers, etc.), a tool for repairing the AV 110 (e.g., screw drivers, car jack, wrench, etc.), and so on), or other types of features that may be inside the AV 110. For instance, the interior sensor 240 can detect a malfunction of an interior feature, which may trigger a request to replace the malfunctioned feature, e.g., by using a 3D printed object. The interior sensor 240 may include multiple interior cameras to capture different views, e.g., to capture views of an interior feature, or portions of an interior feature. The interior sensor 240 may be implemented with a fixed mounting and fixed field of view, or the interior sensor 240 may have adjustable field of views and/or adjustable zooms, e.g., to focus on one or more interior features of the AV 110. The interior sensor 240 may operate continually during operation of the AV 110. The interior sensor 240 may transmit sensor data to a perception module (such as the printing module 360 described below in conjunction with FIG. 3), which can use the sensor data to classify a feature and/or to determine a status of a feature.

The user input sensor 250 provides output from the AV 110 and enables user to provide user input to the AV 110. An example of the user input sensor 250 is a touch screen. The user input sensor 250 may be located above a passenger seat, in a headrest, on an armrest, etc. In some embodiments, one or more other types of user input devices may be disaggregated from a display and located in the passenger compartment, e.g., buttons or a trackpad for controlling a display mounted in the passenger compartment may be located on an armrest or in another location in the passenger compartment, and a passenger can control a display screen using the user input devices. In some embodiments, the user input sensor 250 may be implemented on a personal user device (e.g., the user device 130), and the user device 130 can transmit data received via the user input sensor (e.g., in an app provided by the fleet management system 120) to the AV 110 and/or the fleet management system 120. In some embodiments, the sensor suite 140 may include multiple user input sensors 260, which may have different locations or configurations.

In some embodiments, the user input sensor 250 can receive 3D printing requests from users. The user input sensor 250 enables the users to request 3D printing services provided or enabled by the AV 110. For instance, the user input sensor 250 enables a user to provide information of an object to be 3D printed. The information of the object may include a description of the object, based on which the object can be 3D printed. The description of the object may include an identification of the object, a category of the object, a specification of an attribute of the object, a virtual representation of the object, other types of description of the object, or some combination thereof. The user input sensor 250 may enable the user to provide additional information, such as a location associated with the user (e.g., a pickup location, destination location, etc.), a location associated with the object (e.g., a location where the object should be delivered, a location where the object will be used, etc.), a target time when the object is formed, or other information that may be used to form or use the object.

In some embodiments, the user input sensor 250 enables a user to select the object from a plurality of available objects. An available object is an object that can be formed by an available 3D printer in at least one of the AVs managed by the fleet management system 120. The available objects may be presented in the UI. The available objects may be classified into multiple categories based on one or more attributes, such as function, shape, size, color, material, other attributes, or some combination thereof. The user input sensor 250 may also enable the user to modify a predefined attribute of an available object so that the 3D printed object will have the attribute desired by the user. In other embodiments, the user input sensor 250 may enable the user to design the object. For instance, the UI may allow the user to define one or more attributes of the object. The user input sensor 250 may enable the user to provide a virtual representation (e.g., a 2D or 3D model) of the object. The user input sensor 250 can transmit user inputs to a printing module of the AV 110, e.g., the printing module 360 described below in conjunction with FIG. 3, which can use the user inputs to 3D print objects.

Example Onboard Computer

FIG. 3 is a block diagram showing the onboard computer 160, according to some embodiments of the present disclosure. The onboard computer 160 includes map datastore 310, a sensor interface 320, a perception module 330, a localization module 340, a navigation module 350, and a printing module 360. In alternative configurations, fewer, different and/or additional components may be included in the onboard computer 160. For example, components and modules for conducting route planning, controlling movements of the AV 110, and other vehicle functions are not shown in FIG. 3. Further, functionality attributed to one component of the onboard computer 160 may be accomplished by a different component included in the onboard computer 160 or a different system from those illustrated, such as the fleet management system 120.

The map datastore 310 stores a detailed map of environments through which the AV 110 may travel. The map datastore 310 may store environmental features captured by exterior sensors (e.g., the exterior sensor 210) of the AV 110. In some embodiments, the map datastore 310 may also store environmental features captured by other AVs. In some embodiments, the map datastore 310 includes data describing roadways, such as locations of roadways, connections between roadways, roadway names, speed limits, traffic flow regulations, toll information, etc. The map datastore 310 may further include data describing buildings (e.g., locations of buildings, building geometry, building types), and data describing other objects (e.g., location, geometry, object type) that may be in the environments of an AV. The map datastore 310 may also include data describing other features, such as bike lanes, sidewalks, crosswalks, traffic lights, parking lots, signs, billboards, etc. In some embodiments, the map datastore 310 stores map data for a city or region in which the AV 110 is located.

Some of the map datastore 310 may be gathered by the AV 110. For example, images obtained by exterior sensors (e.g., the exterior sensor 210) of the AV 110 may be used to learn information about the AV′ environments. The output of the exterior sensors may be processed to identify particular conditions in the environment, such as road conditions, weather conditions, etc. In some embodiments, certain map data (e.g., conditions that are expected to be temporary) may expire after a certain period of time. In some embodiments, data captured later by the AV 110 or a different AV may indicate that a previously-observed feature is no longer present (e.g., weather has been changed, construction work zone has been removed, etc.) and in response, the map data may be removed from the map datastore 310.

The sensor interface 320 interfaces with the sensors in the sensor suite 140. The sensor interface 320 is configured to receive data captured by sensors of the sensor suite 140, including data from exterior sensors mounted to the outside of the AV 110, and data from interior sensors mounted in the passenger compartment of the AV 110. The sensor interface 320 may have subcomponents for interfacing with individual sensors or groups of sensors of the sensor suite 140, such as a camera interface, a LIDAR interface, a RADAR interface, a microphone interface, etc.

The sensor interface 320 may also request data from the sensor suite 140, e.g., by requesting that a sensor capture data in a particular direction or at a particular time. For example, the sensor interface 320 may request an interior sensor (e.g., the interior sensor 240) to detect one or more features in the AV 110 periodically to monitor status of the features and to facilitate timely replacement of a feature if the feature malfunctions. As another example, in response to the perception module 330 or another module determining that a feature in the AV 110 malfunctions, the sensor interface 320 instructs the interior sensor to capture additional data (e.g., dimensions, shape, etc.) of the feature, e.g., by zooming in and focusing on the feature. The additional data can be used by the printing module 360 to 3D print a replacement.

The perception module 330 identifies features captured by the sensors of the AV 110. For example, the perception module 330 identifies environmental features and exterior features captured by one or more exterior sensors (e.g., the exterior sensor 210). The perception module 330 can also identify interior features captured by one or more interior sensors (e.g., the interior sensor 240). In some embodiments, the perception module 330 may include one or more classifiers trained using machine learning to identify features. In an embodiment, a multi-class classifier may be used to classify each feature as one of a set of potential features, such as a set of environmental features, a set of exterior features, a set of interior features, or some combination thereof. In another embodiment, a class-specific classifier may be used to classify features in a particular class. For instance, a pedestrian classifier recognizes pedestrians in the environment of the AV 110, a vehicle classifier recognizes vehicles in the environment of the AV 110, etc. The perception module 330 may also identify characteristics of features based on sensor data. Example characteristics of a feature include shape, size, color, material, weight, speed, orientation, and so on. The perception module 330 may further determine status of features based on sensor data. For instance, the perception module 330 may determine whether a feature malfunctions, e.g., whether the feature is broken or whether the feature fails to operate properly.

In some embodiments, the perception module 330 may use data from other sensors (e.g., the LIDAR sensor 220 or the RADAR sensor 230) to identify characteristics or status of a feature. For instance, the perception module 330 may identify travel speeds of identified features based on data from the RADAR sensor 230, e.g., speeds at which other vehicles, pedestrians, or birds are traveling. As another example, the perception module 33—may identify distances to identified features based on data (e.g., a captured point cloud) from the LIDAR sensor 220, e.g., a distance to a particular vehicle, building, or other feature identified by the perception module 330. The perception module 330 fuses data from multiple sources, such as sensors, datastores, other AVs, other systems, etc. In an example, the perception module 330 fuses data from an interior sensor with data from an exterior sensor and/or data from the map datastore 310 to identify environmental features. While a single perception module 330 is shown in FIG. 3, in some embodiments, the onboard computer 160 may have multiple perception modules, e.g., different perception modules for performing different ones of the perception tasks described above (e.g., object perception, speed perception, distance perception, feature perception, facial recognition, mood determination, sound analysis, gaze determination, etc.).

The perception module 330 can request 3D printed objects based on its identification of features, such as environmental features, exterior features, or interior features. For instance, the perception module 330, based on identified features, determines that a 3D printed object is needed to facilitate operation of the AV 110 or to facilitate a service provided by the AV 110. In response to the determination, the perception module 330 can send a 3D printing request to the printing module 360. The 3D printing request may include information of the object that has been determined by the perception module 330, such as the classification of the feature, one or more characteristics of the feature, and so on. In some embodiments, the perception module 330 identifies a malfunctioning feature and requests to form a 3D printed object to replace the malfunctioning feature. In other embodiments, the perception module 330 identifies one or more features and determines that a new object would be needed based on the identified features. For example, the perception module 330 identifies delivery containers (e.g., bags) in the AV 110 and determines that an attachment would be needed to help a user to carry the delivery containers, e.g., based on one or more characteristics (such as number, weight, shape, size, etc.) the delivery containers. Based on the determination, the perception module 330 may request to 3D print the attachment. As another example, the perception module 330 identifies one or more environmental features indicating an adverse weather condition (e.g., snow, hail, etc.) and determines that a tool (e.g., snow shovel, scrapers, etc.) would be needed to deal with the weather condition.

The localization module 340 localizes the AV 110. The localization module 340 may determine an absolute or relative position of the AV 110. The localization module 340 may use features (e.g., environmental features) identified by the perception module 330 to determine where the AV 110 is. Additionally or alternatively, the localization module 340 may receive other data (e.g., sensor data generated by GPS, GNSS, IMU, etc., data from the map datastore 310, data from a user device, and so on) to determine the absolute or relative position of the AV 110. In some embodiments, the localization module 340 determines whether the AV 110 has entered a local area, such as a calibration scene, a parking lot, and so on. The localization module 340 may also determine whether the AV 110 is at a predetermined location (e.g., a pickup location, destination location, etc.). For instance, the localization module 340 may compare the location of the AV 110 with the predetermined location to determine whether the AV 110 has arrived. The localization module 340 may further determine an absolute or relative orientation of the AV 110.

The navigation module 350 controls motion of the AV 110. The navigation module 350 may control the motor of the AV 110 to start, pause, resume, or stop motion of the AV 110. The navigation module 350 may further control the wheels of the AV 110 to control the direction the AV 110 will move. In various embodiments, the navigation module 350 generates a navigation route for the AV 110 based on a location of the AV 110, a destination, and a map. The navigation module 350 may receive the location of the AV 110 from the localization module 340. The navigation module 350 may receive the destination from the fleet management system 120, the user input sensor 250, a user device 130, or other devices or systems. The navigation module 350 may receive the map from the map datastore 310 or an external system, e.g., the fleet management system 120.

In some embodiments, the navigation module 350 may determine motions of the AV 110 on the navigation route. The navigation module 350 may receive environmental features identified by the perception module 330 and determine motions (including current or future) of the AV 110 based on environmental features on the navigation route. In an example, the navigation module 350 may determine vibrations of the AV 110 based on detection of speed bumps on the navigation route. In another example, the navigation module 350 may determine ascending or descending of the AV 110 based on detection of a slope on the navigation route. In yet another example, the navigation module may determine turning of the AV 110 based on detection of a curve the navigation route. In yet another example, the navigation module may determine accelerating of the AV 110 based on detection of an end of a construction work zone or an increase in speed limit. Similarly, the navigation module may determine decelerating (e.g., through braking) of the AV 110 based on detection of a start of a construction work zone or a decrease in speed limit. The navigation module 350 may determine the motions based on other environmental features or determine other types of motions of the AV 110. The navigation module 350 may also generate one or more motion parameters indicating a motion of the AV 110. Example motion parameters may include a speed, velocity, accelerating rate, accelerating direction, decelerating rate, decelerating direction, ascending rate, descending rate, turning direction, turning speed, vibration amplitude, vibration frequency, vibration decay rate, and so on.

The navigation module 350 may adjust motion of the AV 110 to accommodate operations (including current or future operations) of the 3D printer in the AV 110. The navigation module 350 may determine one or more motion parameters based on a 3D printing process that is being performed or to be performed by the 3D printer in the AV during current or future motion of the AV 110. In some embodiments, the navigation module 350 determines or adjusts motion parameters of the AV 110 to minimize the influence of the motion of the AV 110 on the 3D printing process, or to enable the 3D printer to achieve its optimal operation. The navigation module 350 may obtain operation limits of the 3D printer and determine motion parameters based on the operation limits. An operation limit of the 3D printer may be a value or a range of values within which a printing parameter normally should be maintained during operation of the 3D printer. In an example, the navigation module 350 may obtain a limit for the magnitude of vibration of the 3D printer during operation, and the navigation module 350 may determine a speed of the AV 110 moving over speed bumps to keep the vibration magnitude of the 3D printer in the operation limit. Similarly, the navigation module 350 may also determine accelerating rate, decelerating rate, or other motion parameters of the AV 110.

In other embodiments, the navigation module 350 may determine or adjust motion parameters of the AV 110 to facilitate 3D printing processes. The navigation module 350 can determine a motion parameter based on one or more printing parameters. The motion parameter indicates a motion of the AV 110, during which at least part of the 3D printing processes occurs. A printing parameter indicates a desired condition of an item associated with the 3D printing process. The item may be at least part of the 3D printer, a material from which the object is made (such as a material that is extruded and then deposited to form the object), or a portion of the object. The desired condition of the item may be a desired position (e.g., a desired deposition position of a material), a desired movement, a desired moving speed or direction, a desired operation condition (e.g., injection rate of an injector), or other types of desired conditions. The navigation module 350 may determine a motion of the AV 110 that facilitates the desired condition of the item. For instance, the navigation module 350 may receive, e.g., from the printing module 360, information indicating that the 3D printing processes requires a movement of an item, such as at least a part of the 3D printer, a material from which the object is 3D printed, or a portion of the object. The navigation module 350 may determine motions of the AV 110 that can drive the movement of the item. In an example where the 3D printing process requires an item to move in a direction, the navigation module 350 may generate an acceleration of the AV 110 in the opposite direction, which can cause the item to move in the desired direction.

In some embodiments, the navigation module 350 may select a motion parameter from a plurality of candidate motion parameters. For example, the navigation module 350 may predict a condition of an item after the AV 110 moves in accordance with a candidate motion parameter, e.g., by using an approximation method or a kinematic simulation. The navigation module 350 then compares the predicted condition with the desired condition of the item. The navigation module 350 can determine a score of the candidate motion parameter based on a difference between the predicted condition and the desired condition. In an example the item is a material from which the object is printed, and the condition of the material is a deposition position, the navigation module 350 may determine the score based on a spatial distance from the desired deposition position and the predicted deposition position. The navigation module 350 may rank the candidate motion parameters based on their scores and select the motion parameter based on the ranking. For instance, the motion parameter may be the candidate motion parameter that has the lowest or highest score.

The navigation module 350 may determine or modify a navigation route of the AV 110 based on a motion that that can accommodate a 3D printing process. In some embodiments, the navigation module 350 may determine a navigation route having one or more road conditions that enable the AV 110 to make the motion that can accommodate the 3D printing process. The navigation module 350 may determine the one or more road conditions based on the motion and further determine the navigation route based on the one or more road conditions. The navigation module 350 may modify the navigation route to include or avoid the one or more road conditions. Example road conditions include slopes (e.g., upward or downward slopes that can trigger the AV 110 to accelerate or deaccelerate), speed bumps (or other road conditions that may cause the AV 110 to vibrate), curves (which may trigger the AV 110 to turn), and so on. The navigation module 350 may also add a stop during the navigation of the AV 110, and at least a part of the 3D printing process can be performed during the stop.

In some embodiments, the navigation module 350 may use a trained model to determine motion parameters. For instance, the printing module 360 may input one or more environmental features and/or printing parameters into the model, and the model outputs one or more motion parameters. The model has been trained, e.g., by a training module in the navigation module 350 or the fleet management system 120. The training module may apply machine learning techniques to generate the model that when applied to environmental features and/or printing parameters, outputs motion parameters. As part of the generation of the model, the training module may form a training set. The training set includes environmental features and/or printing parameters and motion parameters that indicate motions of AVs in corresponding environments and/or during corresponding 3D printing processes. The training module 380 may extract feature values from the training set, the features being variables deemed potentially relevant to determining motions of AVs. An ordered list of the features may be herein referred to as the feature vector. The training module may apply dimensionality reduction (e.g., via linear discriminant analysis (LDA), principle component analysis (PCA), or the like) to reduce the amount of data in the feature vectors to a smaller, more representative set of training data. The training module 380 may use supervised machine learning to train the model, with the feature vectors of the training set serving as the inputs. Different machine learning techniques—such as stochastic gradient methods, reinforcement learning, supervised learning, semi-supervised learning, linear support vector machine (linear SVM), boosting for other algorithms (e.g., AdaBoost), neural networks (e.g., convolutional neural network), logistic regression, naïve Bayes, memory-based learning, random forests, bagged trees, decision trees, boosted trees, or boosted stumps—may be used in different embodiments.

In some embodiments, the navigation module 350 may use techniques other than machine learning to determine motion parameters, e.g., a closed-loop control (i.e., feedback control), iterative optimization (e.g., iterative non-linear optimization), and so on. The navigation module 350 may provide motion parameters to the motor of the AV 110 and instruct the motor to operate in accordance with the motion parameters. The navigation module 350 may also provide motion parameters to the printing module 360 for the printing module 360 to adjust the operation of the 3D printer based on the motion parameters. In some embodiments, the navigation module 350 (or the printing module 360) may use an approximation method or a kinematic simulation to predict a movement of an item during a motion of the AV 110. A force (e.g., a magnitude and direction of the force) on the item may be estimated based on the motion of the AV 110. Further, the movement of the item under the force is predicted.

The printing module 360 manages the 3D printer in the AV 110. The printing module 360 may initiate and control 3D printing operations performed by the 3D printer. The printing module 360 may receive a request to 3D print an object. In some embodiments, the printing module 360 may receive the request from the perception module 330 based on a determination that a feature of the AV 110 needs to be replaced. The request may include information of the feature, based on which the 3D printer can print a replacement of the feature. The information of the feature may include one or more attributes of the feature, such as shape, size, color, material, weight, etc., and may be determined by the perception module 330 based on data from the sensor suite 140. Additionally or alternatively, the information of the feature may include one or more images of the feature, which may be captured by a camera in the sensor suite 140. In other embodiments, the printing module 360 may receive the request from the fleet management system 120 after the fleet management system 120 receives a 3D printing request from a user and selects the AV 110 to service the 3D printing request. The request from the fleet management system 120 may include information in the user's 3D printing request and other information provided by the fleet management system 120.

The printing module 360 generates printing instructions based on the request and provides the printing instructions to the 3D printer so that the 3D printer can print objects in accordance with the printing instructions. A printing instruction may include a virtual representation of an object to be 3D printed. In some embodiments, the virtual representation includes a 3D model, e.g., a CAD (Computer Aided Design) model, of the object. The printing instruction may also include 2D layers generated from the 3D model of the object. The 3D printer can print each of the 3D layers to form the object. The printing module 360 may include, or otherwise associated with, tools that generate the virtual representation. Examples of the tools include CAD program, slicing software, and so on.

The printing module 360 may generate printing instructions further based on motions of the AV 110. The printing module 360 may receive, such as from the navigation module 350, motion parameters indicating motions of the AV 110. A motion may be a current motion or a predicted future motion of the AV 110, which may be determined by the navigation module 350. The printing module 360 may determine influences of motions of the AV 110 on operations of the 3D printer. The printing module 360 may also modify the operation of the 3D printer to compensate for the influence. For instance, the printing module 360 may determine an influence of a motion of the AV 110 on an item associated with the 3D printing process and adjust a condition of the item or a condition of another item associated with the 3D printing process to compensate for the influence.

In some embodiments, the printing module 360 may predict a movement of an item associated with the 3D printing operation that is caused by a motion of the AV 110, e.g., by using an approximation method or kinematic simulation. Such movement of the item may hinder or facilitate the 3D printing process. The printing module 360 may generate the printing instruction based on the predicted movement of the item and the 3D printing process. The item associated with the 3D printing operation may be a component of the 3D printer, (e.g., an injector that injects a material from which the object is formed, a motor that drives movement of the injector, a light emitter that emits light to cure the material, a support structure on which the object is formed, or other components of the 3D printer), a material from which the object is formed, or a portion (e.g., an uncured layer) of the object itself.

In some embodiments, the printing module 360 may estimate a force to be exerted on an item associated with 3D printing due to a motion of the AV 110 and predict a movement of the item that would be caused by the force. For example, an acceleration (e.g., lateral, vertical, or angular acceleration) of the AV 110 in a direction may cause the item (e.g., the injector, material flow, etc.) to move in the opposite direction. As another example, vibration of the AV 110 may cause the item to vibrate. Other types of motions of the AV 110 (such as deacceleration, turning, ascending, descending, etc.) can also cause movement of the item. The printing module 360 may predict the movement through a kinematic simulation.

In some embodiments, the printing module 360 adjusts the position of an item to offset undesired movement of the item that is caused by a motion of the AV 110. The adjustment of the position of the item may be before, during, or after the motion of the AV 110. In an example, after an acceleration of the AV 110 in a direction that causes an injector of the 3D printer to move in the opposite direction, the printing module 360 may instruct the 3D printer to move the injector back to the desired position. The printing module 360 may determine a position of a movable item after a motion of the AV 110, e.g., based on information from the interior sensor 240 and/or the perception module 330. The printing module 360 may also determine whether the determined position matches a desired position of the movable item and in response to determining that the determined position does not match the desired position, the printing module 360 may move (or instruct the 3D printer to move) the movable item to the desired position.

In other embodiments, the printing module 360 may take advantage of the predicted movement of the item for the 3D printing process. For instance, a stage of the 3D printing process would require a movement of the item, and the required movement is in the same direction as the predicted movement. The printing module 360 may synchronize the state of the 3D printing process with the motion of the AV 110. In an example, a stage of the 3D printing process requires an injector to move in a direction to a desired position before the injector injects a material (e.g., a resin). The printing module 360, based on a determination that the AV 110 will accelerate in the opposite direction, may instruct the 3D printer to perform the stage during the acceleration of the AV 110 is done. The printing module 360 may further determine whether the item is at the desired position after the motion of the AV 110. In response to determining that the item is not at the desired position (e.g., the movement of the item caused by the motion of the AV 110 is insufficient or more than needed), the printing module 360 may then move (or instruct the 3D printer to move) the item to the desired position.

In addition to the position of the item, the printing module 360 may adjust one or more other parameters of the item based on the motion of the AV 110. For instance, the printing module 360 may change moving speed of the item based on the motion of the AV 110. In the example where the motion of the AV 110 promotes the required movement of an item (i.e., the movement required by the 3D printing process), the printing module 360 may reduce the moving speed of the item. The printing module 360 may also adjust an injection rate (i.e., a rate at which the material is injected) based on the motion of the AV 110. In an example where the motion of the AV 110 causes the injector to move faster, the printing module 360 may increase the injection rate so that the same or similar amount of material can be injected. Similarly, the printing module 360 may reduce the injection rate in embodiments where the motion of the AV 110 causes the injector to move slower.

In some embodiments, the printing module 360 may use a model trained through machine learning techniques to optimize operation of the 3D printer in light of motions of the AV 110. For instance, the printing module 360 may input one or more motion parameters into the model, and the model outputs a printing instruction. The model may be trained, e.g., by a training module in the printing module 360, to generate printing instructions based on motion parameters. The training model may use the same or similar machine learning techniques described above. Additionally or alternatively, the printing module 360 may input into the model other types of parameters, such as parameters indicating environmental features of the AV 110 (e.g., road conditions), and so on. In some embodiments, the printing module may use other techniques to generate optimum printing instructions, e.g., a closed-loop control (i.e., feedback control), iterative optimization (e.g., iterative non-linear optimization), and so on.

In other embodiments, the printing module 360 may determine a printing instruction by selecting the printing instruction from a plurality of candidate printing instructions. The printing module 360 may predict the outcome of each candidate printing instruction, e.g., through an approximate model or kinematic simulation. The outcome may indicate an estimated condition of an item. The printing module 360 may determine a score for each candidate printing instruction based on a difference between the estimated condition and a desired condition of the item. In an example the item is a material from which the object is printed, and the condition of the material is a deposition position, the printing module 360 may determine the score based on a spatial distance from the desired deposition position and the predicted deposition position. The printing module 360 may rank the candidate printing instructions based on their scores and select the printing instruction based on the ranking. For instance, the printing instruction may be the candidate printing instruction that has the lowest or highest score.

Example Fleet Management System

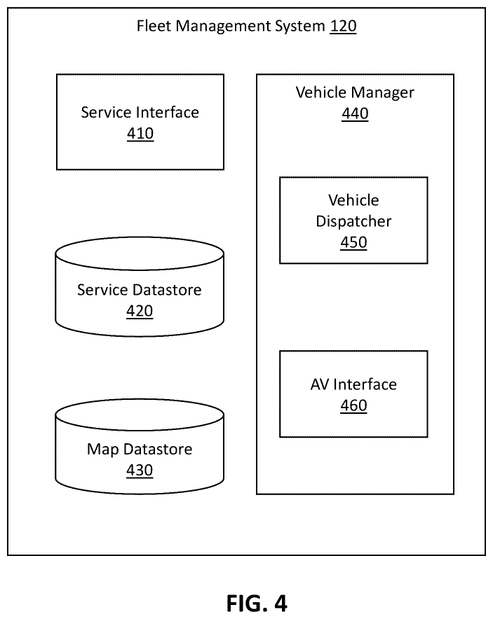

FIG. 4 is a block diagram showing the fleet management system 120, according to some embodiments of the present disclosure. As shown in FIG. 4, the fleet management system 120 includes a service interface 410, a service datastore 420, a map datastore 430, and a vehicle manager 440. In alternative configurations, different and/or additional components may be included in the fleet management system 120. Further, functionality attributed to one component of the fleet management system 120 may be accomplished by a different component included in the fleet management system 120 or a different system than those illustrated, such as the onboard computer 160.

The service interface 410 provides interfaces that allows users (e.g., users 135) to request services that can be provided by AVs associated with the fleet management system 120. In some embodiments, the service interface 410 provides the interfaces to user devices, such as user devices 130. For example, the service interface 410 may provide one or more apps or browser-based interfaces that can be accessed by users, such as the users 135, using user devices. The service interface 410 enables the users to submit service requests provided or enabled by the fleet management system 120 through the interfaces. For instance, the service interface 410 enables a user to submit a 3D printing request that includes information of an object to be 3D printed. The information of the object may include a description of the object, based on which the object can be 3D printed. The description of the object may include an identification of the object, a category of the object, a specification of an attribute of the object, a virtual representation of the object, other types of description of the object, or some combination thereof. The 3D printing request may include additional information, such as a location associated with the user (e.g., a pickup location, destination location, etc.), a location associated with the object (e.g., a location where the object should be delivered, a location where the object will be used, etc.), a target time when the object is formed, or other information that may be used to form or use the object.

In some embodiments, the service interface 410 enables a user to select the object from a plurality of available objects. The service interface 410 may also enable a user to modify a predefined attribute of an available object so that the 3D printed object will have the attribute desired by the user. In other embodiments, the service interface 410 may enable the user 135 to design the object. For instance, the service interface 410 may enable the user to define one or more attributes of the object. The service interface 410 may also enable the user to provide a virtual representation (e.g., a 2D or 3D model) of the object.

The service datastore 420 stores data associated with services managed by the fleet management system 120. The service datastore 420 may store information associated with services that the fleet of AVs can provide. For instance, the service datastore 420 may store information of 3D printing services that the fleet of AVs can provide, such as information of AVs with 3D printers, information about the 3D printers, etc. The service datastore 420 may also store historical service data. For instance, the service datastore 420 may also store service requests that have been made by users. The service datastore 420 may also store information of services that is being performed or has been completed, such as status of service, time when the service was completed, and so on. In some cases, the service datastore 420 may further include future service data, e.g., a future service that a user has scheduled with the fleet management system 120. In some embodiments, service data stored in the service datastore 420 may be associated with user accounts maintained by the fleet management system 120. A user may make service requests or access information of historical service requests through the account of the user.

The map datastore 430 stores a detailed map of environments through which the fleet of AVs may travel. The map datastore 430 may include some or all data stored in map datastores of the AVs, e.g., the map datastore 310. Some of the map datastore 430 may be gathered by a fleet of AVs. For example, images obtained by exterior cameras of the AVs may be used to learn information about the AVs' environments. The images may be processed to identify particular features in the environment. Such features may include road conditions, such as road curve, bumps, traffic lights, traffic cones etc. The fleet management system 120 and/or AVs may have one or more image processing modules to identify features in the captured images or other sensor data. This feature data may be stored in the map datastore 430. In some embodiments, certain feature data (e.g., features that are expected to be temporary) may expire after a certain period of time. In some embodiments, data captured by an AV 110 (e.g., a different AV) may indicate that a previously-observed feature is no longer present (e.g., a traffic cone has been removed) and in response, the fleet management system 120 may remove this feature from the map datastore 430.

The vehicle manager 440 manages and communicates with the fleet of AVs 110. The vehicle manager 440 assigns the AVs 110 to various tasks (e.g., service tasks) and directs the movements of the AVs 110 in the fleet. In some embodiments, the vehicle manager 440 may direct the movements of the AVs 110 in the fleet based on data in the map datastore 430. The vehicle manager 440 includes a vehicle dispatcher 450 and an AV 110 interface 460. In some embodiments, the vehicle manager 440 includes additional functionalities not specifically shown in FIG. 4. For example, the vehicle manager 440 instructs AVs 110 to drive to other locations while not servicing a user, e.g., to improve geographic distribution of the fleet, to anticipate demand at particular locations, etc. The vehicle manager 440 may also instruct AVs 110 to return to an AV 110 facility for fueling, inspection, maintenance, or storage. The vehicle manager 440 may perform some or all of the functions of the onboard computer 160 that are described above in conjunction with FIGS. 1 and 3.

The vehicle dispatcher 450 selects AVs from the fleet to perform various tasks and instructs the AVs to perform the tasks. For example, the vehicle dispatcher 450 receives a 3D printing request from the service interface 410. The vehicle dispatcher 450 selects an AV 110 to service the 3D printing request based on the request, information of the AV 110, and information of the 3D printer in the AV 110. In some embodiments, the vehicle dispatcher 450 selects an AV 110 based on availability of the AV 110. For example, the vehicle dispatcher 450 may determine that the AV 110 is available based on a determination that the AV 110 the AV 110 is not performing any task or is going to perform any task that has been assigned to the AV 110. In cases where the 3D printing request specifies a time window for the formation of the object, the vehicle dispatcher 450 may determine that the AV 110 is available in the time window. The vehicle dispatcher 450 may also determine that the 3D printer is capable to print the object, e.g., based on information of the 3D printer and information of the object in the 3D printing request. In some embodiments (e.g., embodiments where multiple AVs 110 in the AV 110 fleet are available and have capable 3D printers), the vehicle dispatcher 450 may select one of the available AVs based on other factors, such as physical proximity. In an example where the 3D printing request includes a destination location of the object, the vehicle dispatcher 450 may select an available AV 110 that is close to the destination location.

The vehicle dispatcher 450 or another system may maintain or access data describing each of the AVs in the fleet of AVs 110, including current location, service status (e.g., whether the AV 110 is available or performing a service; when the AV 110 is expected to become available; whether the AV 110 is schedule for future service), fuel or battery level, etc. The vehicle dispatcher 450 may select AVs for service in a manner that optimizes one or more additional factors, including fleet distribution, fleet utilization, and energy consumption. The vehicle dispatcher 450 may interface with one or more predictive algorithms that project future service requests and/or vehicle use, and select vehicles for services based on the projections.

The vehicle dispatcher 450 transmits instructions dispatching the selected AVs. In particular, the vehicle dispatcher 450 instructs a selected AV 110 to drive autonomously to a location, such as a location indicated in the 3D printing request. For instance, the vehicle dispatcher 450 may generates a navigation instruction based on the location and provide the navigation instruction to the selected AV, which will then navigate to the location accordingly. The navigation instruction may include the location itself, a navigation route from another location to the location, road condition information, motion parameters, other types of navigation information, or some combination thereof.

The AV 110 interface 460 interfaces with the AVs 110, and in particular, with the onboard computer 160 of the AVs 110. The AV 110 interface 460 may receive sensor data from the AVs 110, such as outputs from the sensor suite 140. The AV 110 interface 460 may further interface with a printing module of an AV 110, e.g., the printing module 360. For example, the AV 110 interface 460 may provide data in the service datastore 420 and/or map datastore 430 to the printing module 460, which may use this data to service a 3D printing request. The AV 110 interface 460 may also provide instructions to AVs 110. For instance, the AV 110 interface 460 may provide an AV 110 information to service a 3D printing request. The information may include navigation information, motion parameters, printing parameters, or some combination thereof.

Example 3D Printer

FIG. 5 illustrates an example 3D printer 500 in an AV 110, according to some embodiments of the present disclosure. The 3D printer 500 may be an embodiment of the 3D printer 150 in FIG. 1. For purpose of simplicity and illustration, the 3D printer 500 in FIG. 5 prints an object 510 by extruding a material 550. The 3D printer 500 includes a support structure 520, an injector 530, and a motor. In other embodiments, the 3D printer 500 may print 3D object based on other technologies, such as photopolymerization, material jetting, binder jetting, power bed fusion, sheet lamination, directed energy deposition, other types of 3D printing technologies, or some combination thereof. Also, the 3D printer 500 include different, more, or fewer components. For instance, the 3D printer 500 may include a light emitter that emit light, such as a laser beam that can be used to print an object by tracing a cross-section of the pattern of the object on a surface of a liquid resin.

As shown in FIG. 5, the injector 530 receives the material 550 and injects the material onto a surface the support structure 520, where the object 510 is formed. The material 550 may be a polymer material. The material 550 may be extruded, e.g., by the injector 530, into a filament shape. In some embodiments, the injector 530 may include a heater that can melt the material 550. The injector 530 moves in the X-Y plane, e.g., in a direction along the X-axis and a direction along the Y-axis, to form layers of the material on the support structure 520 based on the pattern of the object 510. The layers are indicated by the dash lines in FIG. 5. In some embodiments, the thickness of a layer, e.g., a distance between two adjacent dash lines along the Z-axis, may be predetermined. The layers of the material 550 may be cured, e.g., by radiation, heat, etc., to form the object 510. The object 510 may be removed from the 3D printer 500 after it is formed. The object 510 can be used to facilitate operation of the AV 110 or used for other purpose. In an example, the object 510 is used to replace a feature of the AV 110. In another example, the object 510 is used by a user of the AV 110, e.g., to deal with adverse weather conditions or to carry items delivered by the AV 110.

The operation of the 3D printer 500 may be controlled by a printing module of the AV, e.g., the printing module 360 described above in conjunction with FIG. 3. The 3D printer 500 may receive printing parameters from the printing module 360 and print the object 510 in accordance with the printing parameters. The printing parameters may include, for example, printing parameters for the injector 530 (e.g., injector rate, injection time, moving speed, moving direction, etc.), printing parameters for the motor 540, printing parameters for the material 550 (e.g., flow speed, flow direction, curing time, temperature, etc.), and so on. In embodiments where the 3D printer 500 includes other items associated with its operation, such as other components, other materials, or other objects to be printed, the printing module may send other printing parameters to the 3D printer 500.

Example Methods of 3D Printing in AVs

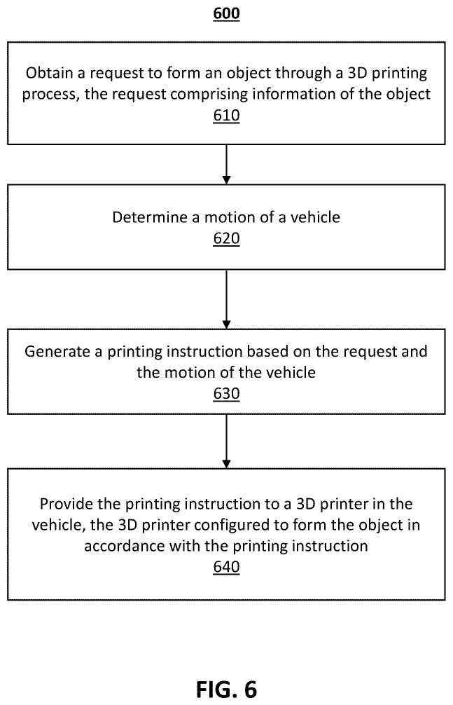

FIG. 6 is a flowchart showing a method 600 of controlling operation of a 3D printer in a vehicle based on a motion of the vehicle, according to some embodiments of the present disclosure. The method 600 may be performed by the onboard computer 160. Although the method 600 is described with reference to the flowchart illustrated in FIG. 6, many other methods of controlling 3D printing based on predicted motion of a vehicle may alternatively be used. For example, the order of execution of the steps in FIG. 6 may be changed. As another example, some of the steps may be changed, eliminated, or combined.

The onboard computer 160 obtains, in 610, a request to form an object through a 3D printing process. The request includes information of the object. In an embodiment, the onboard computer 160 may obtain the request by identifying a feature associated with a vehicle (e.g., AV 110) and determine that the object is to be needed based on the feature. The onboard computer 160 may also identify one or more characteristics of the feature. The request may include information indicating the one or more characteristics of the feature. In another embodiment, the onboard computer 160 may receive the request through a sensor associated with the vehicle. The sensor is configured to receive user inputs. In yet another embodiment, the onboard computer 160 may receive the request from a system that manages the vehicle, such as the fleet management system 120.

The onboard computer 160 determines, in 620, a motion of a vehicle. The onboard computer 160 may determine one or more motion parameters that indicate or specify the motion. In some embodiments, the onboard computer 160 determines a navigation route of the vehicle, e.g., based on a location indicated in the request. The onboard computer 160 may determine the motion based on the navigation route. Additionally or alternatively, the onboard computer 160 may determine the motion based on one or more features in an environment around the vehicle (e.g., weather condition, road condition, etc.), which may be identified by the onboard computer 160 based on sensor data.

The onboard computer 160 generates, in 630, a printing instruction based on the request and the motion parameter of the vehicle. In an embodiment, the onboard computer 160 determines an influence of the motion of the vehicle on a condition of an item associated with the 3D printing process and generates an instruction of adjusting the condition of the item to compensate for the influence. The influence may be a movement of the item that is to be caused by the motion of the vehicle during the 3D printing process. The influence may also be a change in the operation of the item. The item may include at least a part of the 3D printer, a material from which the object is formed through the 3D printing process, or a portion of the object. In an example, the item is an injector that is configured to inject a material from which the object is formed through the 3D printing process. The condition of the item includes a position of the injector, a moving speed of the injector, or a rate of injecting the material. In some embodiments, the onboard computer 160 uses a trained model to generate the printing instruction. For instance, the onboard computer 160 inputs one or more motion parameters into the trained model, and the trained model outputs the printing instruction.

The onboard computer 160 provides, in 640, the printing instruction to a 3D printer in the vehicle. The 3D printer is configured to form the object in accordance with the printing instruction. The object, after it is formed, may be removed from the 3D printer. In some embodiments, the object may be used as a part of the vehicle. For instance, the object may be used to replace a pre-existing feature in the vehicle. The object may also be used to facilitate a service provided by the vehicle or another vehicle. The service may be ride service, delivery service, etc.

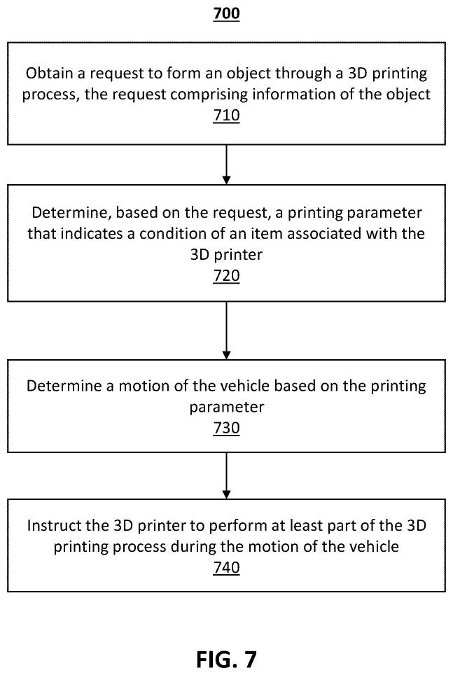

FIG. 7 is a flowchart showing a method 700 of controlling a motion of a vehicle to facilitate operation of a 3D printer in the vehicle, according to some embodiments of the present disclosure. The method 700 may be performed by the onboard computer 160. Although the method 700 is described with reference to the flowchart illustrated in FIG. 7, many other methods of controlling motion of vehicle to facilitate 3D printing may alternatively be used. For example, the order of execution of the steps in FIG. 7 may be changed. As another example, some of the steps may be changed, eliminated, or combined.

The onboard computer 160 obtains, in 710, a request to form an object through a 3D printing process. The request includes information of the object. In an embodiment, the onboard computer 160 may obtain the request by identifying a feature associated with a vehicle (e.g., AV 110) and determine that the object is to be needed based on the feature. The onboard computer 160 may also identify one or more characteristics of the feature. The request may include information indicating the one or more characteristics of the feature. In another embodiment, the onboard computer 160 may receive the request through a sensor associated with the vehicle. The sensor is configured to receive user inputs. In yet another embodiment, the onboard computer 160 may receive the request from a system that manages the vehicle, such as the fleet management system 120.

The onboard computer 160 determines, in 720, based on the request, a printing parameter. The printing parameter indicates a condition of an item associated with the 3D printing process during the 3D printing process. The item may include the item includes at least part of the 3D printer, a material from which the object is to be formed through the 3D printing process, or a portion of the object. The condition may include a movement of the item. The motion may facilitate the movement of the item during the part of the 3D printing process. A direction of the motion to be made by the vehicle may be opposite to a direction of the movement of the item. In an example, the item is an injector of the 3D printer, and the injector is configured to inject a material from which the object is formed during the motion of the vehicle.

The onboard computer 160 determines, in 730, a motion of the vehicle based on the printing parameter. In some embodiments, the printing parameter includes an operation limit of the item. The onboard computer 160 may determine a motion during which the item operates within the operation limit. In some embodiments, the onboard computer 160 may input the printing parameter into a trained model, and the trained model is configured to output the motion of the vehicle.

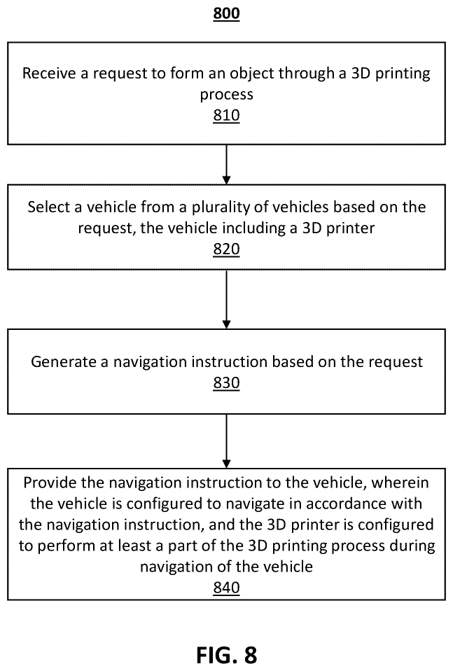

FIG. 8 is a flowchart showing a method 800 of providing 3D printing service by using a vehicle, according to some embodiments of the present disclosure. The method 800 may be performed by the fleet management system 120. Although the method 800 is described with reference to the flowchart illustrated in FIG. 8, many other methods of controlling 3D printing service provided by a vehicle may alternatively be used. For example, the order of execution of the steps in FIG. 8 may be changed. As another example, some of the steps may be changed, eliminated, or combined.

The fleet management system 120 receives, in 810, a request for forming an object through a 3D printing process. In some embodiments, the fleet management system 120 may receive the request from a user device (e.g., user device 130) associated with a user. The fleet management system 120 may facilitate an interface that enables the user to provide information of the object or other information associated with the 3D printing request.

The fleet management system 120 selects, in 820, a vehicle from a plurality of vehicles based on the request. The selected vehicle has a 3D printer. In some embodiments, the fleet management system 120 selects the vehicle based on a determination that the vehicle is available to navigate in accordance with the navigation instruction and that the object can be printed by the 3D printer in the vehicle.

The fleet management system 120 generates, in 830, a navigation instruction based on the request. In some embodiments, the fleet management system 120 may determine a location based on the request. The vehicle can navigate to the location through a navigation route, which may be included in the navigation instruction. In some embodiments, the fleet management system 120 may also determine a motion of the vehicle. The 3D printer is configured to perform the part of the 3D printing process during the motion of the vehicle. The fleet management system 120 may determine, based on the request, a printing parameter that indicates a condition of an item associated with the 3D printing process and determine a motion to be made by the vehicle based on the printing parameter. The printing parameter may include an operation limit of the 3D printer. The fleet management system 120 may determine determining a motion during which the 3D printer can operate within the operation limit.

The fleet management system 120 provides, in 840, the navigation instruction to the vehicle. The vehicle is configured to navigate in accordance with the navigation instruction, and the 3D printer is configured to form at least a portion of the object during navigation of the vehicle. In some embodiments, the fleet management system 120 may also generate a printing instruction, e.g., based on a motion parameter of the vehicle. For instance, the fleet management system 120 may determine a time at which a material or a component of the 3D printer may move based on the motion parameter. Additionally or alternatively, the fleet management system 120 may determine a time at which a portion of the object is to be formed by the 3D printer based on the motion parameter.

In some embodiments, the fleet management system 120 also generates a printing instruction based on the motion of the vehicle. The 3D printer is configured to form the portion of the object in accordance with the printing instruction. The fleet management system 120 may determine an influence of the motion of the vehicle on a condition of an item associated with the 3D printing process and generate an instruction of adjusting the condition of the item to compensate for the influence. The influence may be a movement of the item that is to be caused by the motion of the vehicle during the 3D printing process.

### SELECT EXAMPLES

Example 1 provides a method, including obtaining a request to form an object through a 3D printing process, the request including information of the object; determining a motion of a vehicle; generating a printing instruction based on the request and the motion of the vehicle; and providing the printing instruction to a 3D printer in the vehicle, the 3D printer configured to 3D print the object in accordance with the printing instruction.

Example 2 provides the method of example 1, where generating the printing instruction includes determining an influence of the motion of the vehicle on a condition of an item associated with the 3D printing process; and generating an instruction of adjusting the condition of the item to compensate for the influence.

Example 3 provides the method of example 2, where the item includes a component of the 3D printer, a material from which the object is formed through the 3D printing process, or a portion of the object.

Example 4 provides the method of example 2, where determining the influence of the motion of the vehicle on the condition of the item includes determining a movement of the item that is to be caused by the motion of the vehicle during the 3D printing process.

Example 5 provides the method of example 2, where the item is an injector configured to inject a material from which the object is formed through the 3D printing process, and the condition of the item includes a position of the injector, a moving speed of the injector, or a rate of injecting the material.

Example 6 provides the method of example 1, where generating the printing instruction includes inputting one or more parameters indicating the motion of the vehicle into a trained model, the trained model configured to output the printing instruction.

Example 7 provides the method of example 1, where determining the motion of the vehicle includes determining the motion of the vehicle based on a feature in an environment around the vehicle.

Example 8 provides the method of example 1, where obtaining the request includes identifying a feature associated with the vehicle; and determining that the object is to be needed based on the feature.

Example 9 provides the method of example 8, further including identifying one or more characteristics of the feature, where the request includes information indicating the one or more characteristics of the feature.

Example 10 provides the method of example 1, where obtaining the request includes receiving the request through a sensor associated with the vehicle, the sensor configured to receive user inputs.

Example 11 provides one or more non-transitory computer-readable media storing instructions executable to perform operations, the operations including obtaining a request to form an object through a 3D printing process, the request including information of the object; determining a motion of a vehicle; generating a printing instruction based on the request and the motion of the vehicle; and providing the printing instruction to a 3D printer in the vehicle, the 3D printer configured to 3D print the object in accordance with the printing instruction.

Example 12 provides the one or more non-transitory computer-readable media of example 11, where generating the printing instruction includes determining an influence of the motion of the vehicle on a condition of an item associated with the 3D printing process; and generating an instruction of adjusting the condition of the item to compensate for the influence.

Example 13 provides the one or more non-transitory computer-readable media of example 12, where the item includes a component of the 3D printer, a material from which the object is formed through the 3D printing process, or a portion of the object.

Example 14 provides the one or more non-transitory computer-readable media of example 12, where determining the influence of the motion of the vehicle on the condition of the item includes determining a movement of the item that is to be caused by the motion of the vehicle during the 3D printing process.

Example 15 provides the one or more non-transitory computer-readable media of example 12, where the item is an injector configured to inject a material from which the object is formed through the 3D printing process, and the condition of the item includes a position of the injector, a moving speed of the injector, or a rate of injecting the material.

Example 16 provides the one or more non-transitory computer-readable media of example 11, where generating the printing instruction includes inputting one or more parameters indicating the motion of the vehicle into a trained model, the trained model configured to output the printing instruction.

Example 17 provides the one or more non-transitory computer-readable media of example 16, where determining the motion of the vehicle includes determining the motion of the vehicle based on a feature in an environment around the vehicle.

Example 18. A computer system, including a computer processor for executing computer program instructions; and one or more non-transitory computer-readable media storing computer program instructions executable by the computer processor to perform operations including obtaining a request to form an object through a 3D printing process, the request including information of the object, determining a motion of a vehicle, generating a printing instruction based on the request and the motion of the vehicle, and providing the printing instruction to a 3D printer in the vehicle, the 3D printer configured to 3D print the object in accordance with the printing instruction.

Example 19 provides the computer system of example 18, where generating the printing instruction includes determining an influence of the motion of the vehicle on a condition of an item associated with the 3D printing process; and generating an instruction of adjusting the condition of the item to compensate for the influence.

Example 20 provides the computer system of example 18, where obtaining the request includes identifying a feature associated with the vehicle; and determining that the object is to be needed based on the feature.

Example 21 provides a method, including obtaining a request to form an object through a 3D printing process, the request including information of the object; determining, based on the request, a printing parameter that indicates a condition of an item associated with the 3D printing process; determining a motion to be made by the vehicle based on the printing parameter; and instructing the 3D printer to perform at least a part of the 3D printing process during the motion of the vehicle.

Example 22 provides the method of example 21, where the item includes at least part of the 3D printer, a material from which the object is to be formed through the 3D printing process, or a portion of the object.

Example 23 provides the method of example 21, where the condition includes a movement of the item, and the motion is configured to facilitate the movement of the item during the part of the 3D printing process.

Example 24 provides the method of example 23, where a direction of the motion to be made by the vehicle is opposite to a direction of the movement of the item.

Example 25 provides the method of example 21, where the printing parameter includes an operation limit of the item, and determining the motion including determining the motion during which the item operates within the operation limit.

Example 26 provides the method of example 21, where the item is an injector of the 3D printer, the injector is configured to inject a material from which the object is formed during the motion of the vehicle.

Example 27 provides the method of example 21, where determining the motion includes inputting the printing parameter into a trained model, the trained model configured to output the motion.

Example 28 provides the method of example 21, where obtaining the request includes identifying a feature associated with the vehicle; and determining that the object is to be needed based on the feature.

Example 29 provides the method of example 28, further including identifying one or more characteristics of the feature, where the request includes information indicating the one or more characteristics of the feature.

Example 30 provides the method of example 21, where obtaining the request includes receiving the request through a sensor associated with the vehicle, the sensor configured to receive user inputs.

Example 31 provides a method, including receiving a request for forming an object through a 3D printing process; selecting a vehicle from a plurality of vehicles based on the request, the vehicle including a 3D printer; generating a navigation instruction based on the request; and providing the navigation instruction to the vehicle, where the vehicle is configured to navigate in accordance with the navigation instruction, and the 3D printer is configured to perform at least a part of the 3D printing process during navigation of the vehicle.

Example 32 provides the method of example 31, where generating the navigation instruction based on the request includes determining a location based on the request, the vehicle configured to navigate to the location based on the navigation instruction.

Example 33 provides the method of example 31, where selecting the vehicle includes determining that the vehicle is available to navigate in accordance with the navigation instruction; and determining that the object can be printed by the 3D printer in the vehicle.

Example 34 provides the method of example 31, where generating the navigation instruction based on the request includes determining a motion of the vehicle, the 3D printer configured to perform the part of the 3D printing process during the motion of the vehicle.

Example 35 provides the method of example 34, further including generating a printing instruction based on the motion of the vehicle, where the 3D printer is configured to perform the part of the 3D printing process in accordance with the printing instruction.

Example 36 provides the method of example 35, where generating the printing instruction based on the motion of the vehicle includes determining an influence of the motion of the vehicle on a condition of an item associated with the 3D printing process; and generating an instruction of adjusting the condition of the item to compensate for the influence.

Example 37 provides the method of example 36, where determining the influence of the motion of the vehicle on the condition of the item includes determining a movement of the item that is to be caused by the motion of the vehicle during the 3D printing process.

Example 38 provides the method of example 31, where generating the navigation instruction based on the request includes determining, based on the request, a printing parameter that indicates a condition of an item associated with the 3D printing process; and determining a motion to be made by the vehicle based on the printing parameter; and

Example 39 provides the method of example 38, where the printing parameter includes an operation limit of the 3D printer, and determining the motion including determining the motion so that the 3D printer operates within the operation limit during the motion of the vehicle.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
obtaining a request to form an object through a three-dimensional (3D) printing process, the request comprising information of the object;
determining a motion of a vehicle;
generating a printing instruction based on the request and the motion of the vehicle; and
providing the printing instruction to a 3D printer in the vehicle, the 3D printer configured to 3D print the object in accordance with the printing instruction.

2. The method of claim 1, wherein generating the printing instruction comprises:
determining an influence of the motion of the vehicle on a condition of an item associated with the 3D printing process; and
generating an instruction of adjusting the condition of the item to compensate for the influence.

3. The method of claim 2, wherein the item includes a component of the 3D printer, a material from which the object is formed through the 3D printing process, or a portion of the object.

4. The method of claim 2, wherein determining the influence of the motion of the vehicle on the condition of the item comprises:
determining a movement of the item that is to be caused by the motion of the vehicle during the 3D printing process.

5. The method of claim 2, wherein the item is an injector configured to inject a material from which the object is formed through the 3D printing process, and the condition of the item includes a position of the injector, a moving speed of the injector, or a rate of injecting the material.

6. The method of claim 1, wherein generating the printing instruction comprises:
inputting one or more parameters indicating the motion of the vehicle into a trained model, the trained model configured to output the printing instruction.

7. The method of claim 1, wherein determining the motion of the vehicle comprises:
determining the motion of the vehicle based on a feature in an environment around the vehicle.

8. The method of claim 1, wherein obtaining the request comprises:
identifying a feature associated with the vehicle; and
determining that the object is to be needed based on the feature.

9. The method of claim 8, further comprising:
identifying one or more characteristics of the feature, wherein the request includes information indicating the one or more characteristics of the feature.

10. The method of claim 1, wherein obtaining the request comprises:
receiving the request through a sensor associated with the vehicle, the sensor configured to receive user inputs.

11. One or more non-transitory computer-readable media storing instructions executable to perform operations, the operations comprising:
obtaining a request to form an object through a three-dimensional (3D) printing process, the request comprising information of the object;
determining a motion of a vehicle;
generating a printing instruction based on the request and the motion of the vehicle; and
providing the printing instruction to a 3D printer in the vehicle, the 3D printer configured to 3D print the object in accordance with the printing instruction.

12. The one or more non-transitory computer-readable media of claim 11, wherein generating the printing instruction comprises:
determining an influence of the motion of the vehicle on a condition of an item associated with the 3D printing process; and
generating an instruction of adjusting the condition of the item to compensate for the influence.

13. The one or more non-transitory computer-readable media of claim 12, wherein the item includes a component of the 3D printer, a material from which the object is formed through the 3D printing process, or a portion of the object.

14. The one or more non-transitory computer-readable media of claim 12, wherein determining the influence of the motion of the vehicle on the condition of the item comprises:
determining a movement of the item that is to be caused by the motion of the vehicle during the 3D printing process.

15. The one or more non-transitory computer-readable media of claim 12, wherein the item is an injector configured to inject a material from which the object is formed through the 3D printing process, and the condition of the item includes a position of the injector, a moving speed of the injector, or a rate of injecting the material.

16. The one or more non-transitory computer-readable media of claim 11, wherein generating the printing instruction comprises:
inputting one or more parameters indicating the motion of the vehicle into a trained model, the trained model configured to output the printing instruction.

17. The one or more non-transitory computer-readable media of claim 16, wherein determining the motion of the vehicle comprises:
determining the motion of the vehicle based on a feature in an environment around the vehicle.

18. A computer system, comprising:
a computer processor for executing computer program instructions; and
one or more non-transitory computer-readable media storing computer program instructions executable by the computer processor to perform operations comprising:
obtaining a request to form an object through a three-dimensional (3D) printing process, the request comprising information of the object;
determining a motion of a vehicle;
generating a printing instruction based on the request and the motion of the vehicle; and
providing the printing instruction to a 3D printer in the vehicle, the 3D printer configured to 3D print the object in accordance with the printing instruction.

19. The computer system of claim 18, wherein generating the printing instruction comprises:
determining an influence of the motion of the vehicle on a condition of an item associated with the 3D printing process; and
generating an instruction of adjusting the condition of the item to compensate for the influence.

20. The computer system of claim 18, wherein obtaining the request comprises:
identifying a feature associated with the vehicle; and
determining that the object is to be needed based on the feature.
